(19) United States
(12) Patent Application Publication
(10) Pub. No.: US 2008/0111275 A1
(43) Pub. Date: May 15, 2008

(54) System And Method For Rotary Forging

(76) Inventors: Mark James Kline, Okeana, OH (US); Jeromy Thomas Raycheck, Lebanon, OH (US); Urmish Popatal Dalal, Milford, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/937,060

(22) Filed: Nov. 8, 2007

Related U.S. Application Data
(60) Provisional application No. 60/858,078, filed on Nov. 10, 2006.

(51) Int. Cl. B29C 47/06

(52) U.S. Cl. 264/266; 425/515

(57) ABSTRACT

A system and method are provided for forming thermoplastic material using rotary forging. A volume of a thermoplastic material is delivered. The thermoplastic material is transported between a first rotating forging device and a second rotating forging device. The first forging device defines a first forging region in its surface, which receives the thermoplastic material. The thermoplastic material is at or above a forging temperature and flows into the first void region and shapes a core element from the thermoplastic material. The thermoplastic material is substantially solidified into the core element. Then, the core element is transferred from the first rotating forging device.

### CROSS REFERENCE TO RELATED APPLICATION

This application claims the benefit of U.S. Provisional Application No. 60/858,078, filed Nov. 10, 2006, the substance of which is incorporated herein by reference.

### FIELD OF THE INVENTION

This invention relates generally to a system and method for making a product or component, and more specifically to a system and method for making a component from a thermoplastic material.

### BACKGROUND OF THE INVENTION

Many materials can be shaped. For example, metal products may be shaped by forging. Plastic materials may also be shaped. Various polymers are known to be thermoplastic. Thermoplastic materials can exhibit such behaviors as being plastic or deformable, melting when heated, and solidifying when cooled. Thermoplastic materials may also be heated until softened and then deformed. Thermosetting polymers, in contrast, are heavily cross-linked polymers and cannot be remelted or reformed after being cast and cured.

One example of a product component that may include a thermoplastic material is a surface fastener. Surface fasteners are commonly used in a variety of applications, often to join a first surface to a second surface, thereby connecting a first and second portion of an article in a face-to-face relationship. Surface fasteners also may be used to secure one article to another, or to secure a first portion of an article to a second portion in some desired manner. Surface fasteners may be used in a variety of applications, including consumer products. For example, surface fasteners may be used with absorbent articles, such as diapers; to secure, open, or close packaging of any of a variety of products or substances; for medical products, such as bandages or wound care dressings; etc.

Various fasteners may be used for the purposes recited above. An example of a suitable fastener includes those generically referred to as “macrofasteners.” “Macrofastener” refers to any large, interlocking fastener. Common examples of macrofasteners include buckles, tabs and slots, hooks and eyes, buttons, zippers, snaps, and the like. Macrofasteners tend to provide good alignment of parts to be connected. They typically only interlock with themselves and do not stick to other objects, and many embodiments disengage quietly. Macrofasteners are useful in various contexts, including for closing absorbent articles such as diapers.

Due to the nature of their design, some macrofasteners may be somewhat rigid to prevent significant deformation during the engagement process and in use under stress. Such deformation may cause the two fastener components to form shapes that do not readily mate together. Therefore, such macrofastener construction may include forming stiffer plastic core elements that make up the fastener's backbone, and surrounding them in soft nonwoven material. For example, reinforcing plastic elements may be used with tab-and-slot macrofasteners to improve their ability to interconnect, to remain interconnected, and to retain the proper orientation.

Various methods may be used to form the stiffer, reinforcing core plastic elements of such macrofasteners. One known method of forming the parts is to extrude thick plastic films and die cut or punch them into shapes, and then laminate them into the nonwoven material in a linear fashion. This method may limit the design to having only a single thickness throughout the entire core element. This method also may limit the ability to produce part geometry of reduced part mass usage, because it may use several small punch operations that cause loose pieces that can complicate and add cost to the forming process. Additionally, die cutting and punching usually result in high scrap rates if the material cannot be recycled into the initial melt.

Another known method of forming core fastener elements is called thermoplastic printing, described in PCT International Publication Number WO 03/039868 A1. This method uses very hot, molten plastic that is deposited into cells or void regions that are the shape of the core elements, and then printed or otherwise deposited onto a nonwoven material. This forming method may have drawbacks. One such drawback is that the plastic core element is typically at a higher melt temperature than the nonwoven material onto which it is deposited. Typically, using such nonwovens as polyethylene terephthalate can be higher cost versus similar nonwovens with lower melt temperatures, such as polypropylene. Another drawback with printing is that the core elements tend to smear onto the nonwovens resulting in a suboptimal shape.

### BRIEF SUMMARY OF THE INVENTION

In one aspect of the present invention, a method is provided for forming thermoplastic material using rotary forging. A volume of a thermoplastic material substantially at a temperature at or above its forging temperature is delivered. The thermoplastic material is transported between a first rotating forging device and a second rotating forging device. The first forging device defines a first forging region in its surface, which receives the thermoplastic material. The thermoplastic material flows into the first forging region and shapes a core element from the thermoplastic material. The thermoplastic material is substantially solidified into the core element. Then, the core element is transferred from the first rotating forging device.

In an embodiment, the thermoplastic material is delivered in a semi-solid state, and in an embodiment, the second rotating forging device also defines a forging region on its surface, where the two voids sandwich the thermoplastic material to shape it. In another embodiment, the temperature of the thermoplastic material may be reduced below the forging temperature of the thermoplastic material by chilling at least one of the forging devices.

In another aspect of the present invention, a rotary forging system is provided for forming core elements of a desired shape from extrudates. The system includes an extrusion die configured to deliver a volume of a thermoplastic material at a temperature at or above its forging temperature. The system further includes a first rotating forging device defining a first forging region in its surface. The system also includes a second rotating forging device arranged proximate the first forging device. The second rotating forging device is positioned to receive the thermoplastic material from the extrusion die and transport it between the first rotating forging device and the second rotating forging device. The forging devices thereby align the thermoplastic material into the first forging region and shape a core element from the thermoplastic material. The second forging device has a temperature below the forging temperature of the thermoplastic material sufficient to substantially solidify the thermoplastic material into the core element.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1A is a front elevation view of an embodiment of an apparatus of the present invention for rotary forging a material;

FIG. 1B is a graph illustrating material properties of a polymeric material as functions of temperature.

FIG. 2 is a front elevation view of an embodiment of an apparatus of the present invention for rotary forging a material illustrating a position of the extrusion die, wherein the extrudate is supplied to a forging devices having void regions;

FIG. 3 is a front elevation view of an embodiment of an apparatus of the present invention for rotary forging a material illustrating another position of the extrusion die, wherein the extrudate is supplied to a forging devices having a smooth surface;

FIG. 4 is a front elevation view of an embodiment of an apparatus of the present invention for rotary forging a material illustrating another position of the extrusion die, wherein gravity is used to direct the extrudate to the forging devices;

FIG. 5A is a front elevation view of forging devices, wherein the forging devices have smooth surfaces;

FIG. 5B is a front elevation view of forging devices in accordance with an embodiment of the present invention, wherein one forging device has void regions;

FIG. 5C is a front elevation view of forging devices in accordance with an embodiment of the present invention, wherein one forging device has protrusions;

FIG. 5D is a front elevation view of forging devices in accordance with an embodiment of the present invention, wherein the forging devices have void regions;

FIG. 5E is a front elevation view of forging devices in accordance with an embodiment of the present invention, wherein one forging device has void regions and the one forging device has protrusions;

FIG. 5F is a front elevation view of forging devices in accordance with an embodiment of the present invention, wherein the forging devices have protrusions;

FIG. 5G is a front elevation view of forging devices in accordance with an embodiment of the present invention, wherein the forging devices have a combination of void regions and protrusions;

FIG. 6 is a partial elevation view of a forging device in accordance with an embodiment of the present invention, wherein the peripheral surface of the forging device has a protrusion further having an integrated void region;

FIG. 7A is a plan view of a forging device in accordance with an embodiment of the present invention;

FIG. 7B is a partial sectional view of an embodiment of surfaces of a forging device in accordance with an embodiment of the present invention;

FIG. 7C is a partial sectional view of an embodiment of surfaces of a forging device in accordance with an embodiment of the present invention;

FIG. 7D is a partial sectional view of an embodiment of surfaces of a forging device in accordance with an embodiment of the present invention;

FIG. 8A is a perspective view of a carrier film and core element in accordance with an embodiment of the present invention;

FIG. 8B is a partial cross-sectional view of an embodiment of a core element with a carrier film formed with a forging device in accordance with an embodiment of the present invention.

FIG. 8C is a partial cross-sectional view of an embodiment of a core element with a carrier film formed with a forging device in accordance with an embodiment of the present invention.

FIG. 8D is a partial cross-sectional view of an embodiment of a core element with a carrier film formed with a forging device in accordance with an embodiment of the present invention.

FIG. 9 illustrates a molded web with forged macrofastener core elements in accordance with an embodiment of the present invention;

FIG. 10 is a front elevation view of an embodiment of an apparatus of the present invention for bonding nonwoven material and die cutting a web;

FIG. 11 is a plan view of a die cut slot fastener web;

FIG. 12 is a plan view of the die cut slot fastener web of FIG. 11 without the scrap material and with the core elements separated;

FIG. 13A is a front elevation view of core elements on a carrier film in accordance with an embodiment of the present invention, wherein the core elements are X distance apart;

FIG. 13B is a front elevation view of core elements on a carrier film in accordance with an embodiment of the present invention, wherein the core elements are Y distance apart;

FIG. 14A is a front elevation view of a forging device with pivotable segments in accordance with an embodiment of the present invention, shown prior to segment 820a accelerating;

FIG. 14B is a front elevation view of the forging device of FIG. 14A, shown after segment 820a accelerates;

FIG. 15 is a front elevation view of conveyor system in accordance with an embodiment of the present invention.

### DETAILED DESCRIPTION OF THE INVENTION

The term “absorbent article” as used herein refers to a device that normally absorbs and retains fluids. In certain instances, the phrase refers to devices that are placed against or in proximity to the body of the wearer to absorb and contain the excreta and/or exudates discharged from the body, and includes such personal care articles as fastened diapers, pull-on diapers, training pants, swim diapers, adult incontinence articles, feminine hygiene articles, and the like. In other instances, the term also refers to protective or hygiene articles, for example, bibs, wipes, bandages, wraps, wound dressings, surgical drapes, etc.

The term “diaper” refers to an absorbent article generally worn by infants and incontinent persons about the lower torso and typically having a fastening system to connect a back waist region with the front waist region in a closed configuration so as to provide lateral tensions about the circumference of the diaper to hold the article on the wearer.

The term “prefastened disposable article” or “prefastened article” refers herein to disposable absorbent articles that are provided to consumers in a prefastened configuration of the fastening system (i.e., the fastening system is engaged to form a closure) of the article and that are intended to be put on the wearer by putting legs through leg openings of the article.

The terms “pull-on diaper” and/or “training pants” refer herein to disposable absorbent articles typically having a fixed, closed configuration around the waist of the wearer and that are intended to be put on the wearer by putting legs through leg openings of the article.

The term “web” as used herein refers to any continuous material, including a film, a thermoplastic film, a nonwoven fabric, a woven fabric, a dry lap material including wood pulp, a foam, and the like, or a combination thereof, having a single layer or multiple layers.

The term “substrate” as used herein refers to any material, including a film, a thermoplastic web, a nonwoven web, a woven web, a foam a dry lap material including wood pulp, cellulosic material, derivatized or modified cellulosic materials, etc., and the like, or a combination thereof, having a single layer or multiple layers.

The term “fibrous substrate” as used herein refers to a material comprised of a multiplicity of fibers that could be either a natural or synthetic material or any combination thereof, for example, nonwoven materials, woven materials, knitted materials, and any combinations thereof.

The term “nonwoven” as used herein refers to a fabric made from continuous filaments and/or discontinuous fibers without weaving or knitting by processes such as spun-bonding, carding, and melt-blowing. The nonwoven fabric can comprise one or more nonwoven layers, wherein each layer can include continuous filaments or discontinuous fibers. Nonwovens can also comprise bi-component fibers, which can have shell/core, side-by-side, or other known fiber structures.

The term “thermoplastic material” refers herein to any polymeric material or composition that becomes soft when heated and hard when cooled, and that may be forged into a desired form.

The term “forging” as used herein refers to any process of forming a molded part by a press or other pressing device with our without heat.

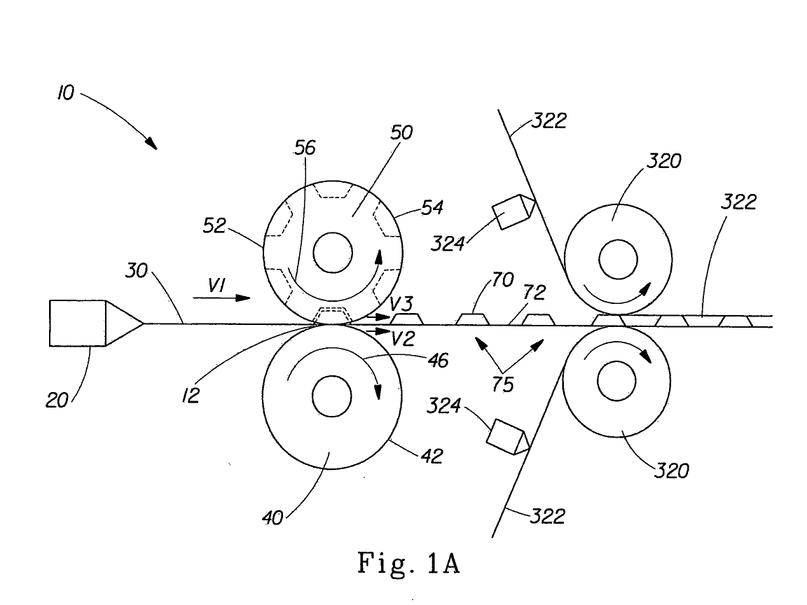

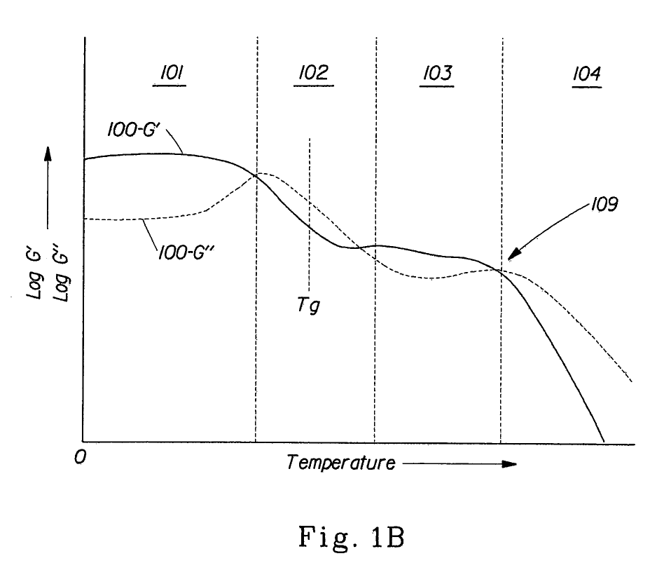

FIG. 1A is a front plan view of an embodiment of a system and method for forming extrudates using a rotating drum in accordance with the principles of the present invention. Other embodiments may comprise other forms of forging devices, such as, but not limited to, segments that follow a rotary path, a rotating wheel, a continuous or segmented belt, etc., some of which are described herein. A rotary forging system 10 depicted in FIG. 1A may include an extrusion die 20 arranged to deliver a supply of thermoplastic material as an extrudate 30, which is then passed through forging devices 40 and 50. Forging devices 40 and 50 may perform a portion of a “mass redirection” process, as described in further detail below, to integrally form core elements 70 with a carrier film 72. An embodiment of the mass redirection process includes subjecting a thin, essentially flat sheet of material to pressure to cause the material to be redirected by voids or protrusions of the forging devices 40 and 50, such that some areas of the sheet of material become thinner while other areas become thicker. That is, the mass of the material may flow from one region of the sheet to another.

The system 10 may be used with materials composed of thermoplastic polymers such as polyolefins (including but not limited to polypropylene and polyethylene), polyethylene terephthalate, polyamide, elastic polyolefins, other thermoplastic polyolefins, and combinations thereof. Other thermoplastic materials also may be used. Specific examples of suitable materials include but are not limited to Exxact™ and Vistamax™ available from Exxon. Examples of suitable polypropylene materials include Moplen™, Metocene™, Adstif™, Clyrell™, Pro-Fax™, and Pro-Fax Ultra™ available from Basell Polyolefins. Examples of suitable polyethylene materials include Lupolen™, Lucalen™, and Hostalen™, also available from Basell Polyolefins. The thermoplastic material may be made of any material capable of yielding the desired properties and bearing loads appropriate for its intended use. It is to be understood that, while the system and method is discussed primarily with respect to thermoplastics, various additive and/or filler materials can be added to thermoplastics used with the present invention. Examples of such materials include particles and/or fibers of woods, metals, ceramics, composite materials, etc.

In an embodiment, resultant core elements formed in the extrudates may be an end product. In other embodiments, the resultant core elements formed in the extrudates may be included or attached to other components, or otherwise processed, to form an end product. The core elements may be used to form fasteners or other components. The elements may be used in a number of products, such as disposable absorbent articles, including fastened diapers, pull-on diapers, training pants, swim diapers, and adult incontinence articles. Such core elements may further be used to form fasteners, components for other disposable or durable products, product packaging or packaging subassemblies, and any other suitable product. In an embodiment, described in more detail herein, the core elements are used to form a tab-and-slot fastening system for disposable absorbent articles.

While the system and method is discussed primarily with respect to forming components for macrofasteners, the discussion of forming components for macrofasteners is for purposes of example only. The system and method may be used to make any suitable desired product or component. Examples of products or product components that may be manufactured with the system and method disclosed herein include, but are not limited to, toothbrush handles, packaging (such as container lids, etc.), floss picks, belt buckles, toys, automotive parts, other thermoplastic articles of varying thicknesses, and so on.

With further reference to the embodiment shown in FIG. 1A, the rotary forging system 10 of the present invention may be suitable for forming core elements 70 of a desired shape integrally with a carrier film 72 from extrudates supplied to the system 10 in accordance with the principles of the present invention. The rotary forging system 10 depicted in FIG. 1A may include an extrusion die 20, a first forging device 40 having a generally cylindrical shape and a peripheral surface 42 about the circumference of the device 40, and a second forging device 50 having a generally cylindrical shape and a peripheral surface 52 about the circumference of the device 50. The second forging device 50 is situated adjacent the first forging device 40 such that the peripheral surface 52 of the second forging device 50 is in contact with, or proximate to, the peripheral surface 42 of the first forging device 50. Alternatively, the second forging device 50 may be situated such that the peripheral surface 52 is any desired distance from the peripheral surface 42, depending on the characteristics and shape of the desired core element 70 and the carrier film 72. The central axis of the second forging device 50 is generally parallel to the central axis of the first forging device 40. As situated, a point of tangency 12 is created between the first and second forging devices 40 and 50, such that at the point where the peripheral surface 42 is most near the peripheral surface 52, material passing between the first and second forging devices 40 and 50 will be generally aligned tangent to both the peripheral surfaces 42 and 52. The forging devices 40 and 50 may be formed of any suitable material, including metals, plastics, composites, wood, or any other material capable of bearing the mechanical loads and temperature conditions, described in further detail below, in the forging process.

The following description of the present invention in operation relates to the embodiment shown in FIG. 1A. It shall be recognized, however, that the operation is applicable to any of the embodiments of forging devices 40 and 50 mentioned herein, including embodiments with protrusions rather than, or in combination with, void regions. Characteristics applicable to void regions are similarly applicable to protrusions. With reference to FIG. 1A, the second forging device 50, in an embodiment, includes one or more void regions 54 about the peripheral surface defining a pattern on the peripheral surface 52. The pattern defined on the peripheral surface 52 of the second forging device 50 may result in a core element 70 of any desired shape, including any width, length, height, and depth. That is, the void regions 54, described in more detail below, may comprise a variety of shapes and sizes to form the desired core element 70. Moreover, the void regions 54 may be of any desired depth throughout, so that some portions of a void region 54 may be one particular depth while other portions of the void region 54 are one or more other depths. In some embodiments, dissimilarly shaped void regions 54 may be provided by the second forging device 50. That is, the pattern defined on the peripheral surface 52 of the second forging device 50 may comprise a plurality of void regions 54, each having the same shape, each having a different shape, or any combination thereof, as desired. Furthermore, the pattern defined on the peripheral surface 52 may include a continuous void region 54 around the entire peripheral surface 52.

In operation, first forging device 40 and second forging device 50 rotate as indicated by the rotation arrows 46 and 56 on the devices. Generally, the forging devices 40 and 50 will rotate in opposite directions, such that first forging device 40 will rotate clockwise about its central axis, and second forging device 50 will rotate counterclockwise about its central axis.

Extrusion die 20 delivers a supply of thermoplastic material as an extrudate 30 to the forging devices 40 and 50. Extrudate 30 moves toward forging devices 40 and 50 at a first velocity V1. Peripheral surface 42 of first forging device 40 is moving at a second velocity V2. Peripheral surface 52 of second forging device 50 is moving at a third velocity V3. Velocities V1, V2, and V3 are each greater than 0 m/min. In an embodiment, velocity V1 is equal to both velocity V2 and velocity V3. In other embodiments, velocity V1 may be different than at least one of the two other velocities. In yet other embodiments, velocity V2 is different that at least one of the other velocities. Any combination of velocities may be used. Velocities V1, V2, and V3 are all greater than 0 meters/minute. In some embodiments, velocity V1 is at least 10 meters/minute. Alternatively, velocity V1 is at least 30 m/min, at least 50 n/min, or at least 150 m/min.

The thermoplastic material can be extruded continuously, or it may be extruded discontinuously, such as in strips or in some other suitable manner. The extrusion die 20 need not generate pressure to push the extrudate 30 into the void regions 54 of the forging device 50. Rather, the forging devices 40 and 50 may provide the pressure to fill the void regions 54. Typically, the extrudate 30 is maintained at an appropriate temperature to retain a semi-solid state from the extrusion die 20 until it is passed through the forging devices 40 and 50. Generally, the mass redirection process of the forging system 10 will occur while the thermoplastic material is at a temperature that is high enough for the mass redirection to readily occur, but not so high that once the material is removed from the forging device that the material flows into a different shape. The thermoplastic materials supplied as an extrudate 30 typically subjected to the mass redirection process of the present system 10 have viscous and elastic characteristics. At some temperatures, the elastic characteristic dominates. Mass redirection at these temperatures may be ineffective as the material may be difficult to form. As such, high pressures and high dwell times, i.e., the length of time, or time period, that the mass of the extrudate 30 is being redirected, may be needed. This may be undesirable for high speed, reliable processing. At other temperatures, the viscous characteristic dominates. Generally, the mass redirection process of the forging system 10 occurs while the thermoplastic material is above the temperature at which the elastic characteristic dominates the viscous characteristic.

For any given material, the characteristic which dominates depends on the temperature of the material, as illustrated in the graph of FIG. 1B, and also on the process parameters (e.g. speed).

FIG. 1B is a graph illustrating material properties of a polymeric material as functions of temperature. The graph of FIG. 1B illustrates a shear storage modulus of elasticity curve 100-G′ and a loss modulus of elasticity curve 100-G″ wherein the vertical axis is a logarithmic scale of the storage modulus and the loss modulus while the horizontal axis is a linear scale of temperature. The graph of FIG. 1B illustrates a glassy region 101, a transition region 102, a rubbery plateau region 103, and a terminal region 104. The graph of FIG. 1B also includes Tg, which is a glass transition temperature, located in the middle of the transition region 102. The polymeric material tends to act glassy at temperatures below the Tg and tends to act rubbery at temperatures above the Tg. The polymeric material is substantially solid at temperatures below the rubbery plateau region 103, semi-solid in the rubbery plateau region 103, and substantially melted in the terminal region 104.

The shear storage modulus of elasticity curve 100-G′ and the loss modulus of elasticity curve 100-G″ cross over each other at cross over point 109, which is on the boundary between the rubbery plateau region 103 and the terminal region 104. Throughout the present disclosure, references to a cross over point refer to a point at which a shear storage modulus of elasticity curve and a loss modulus of elasticity curve cross over each other on the boundary between a rubbery plateau region and a terminal region, such as the cross over point 109. A graph illustrating material properties of a polymeric material as functions of temperature can be generated in various ways, as will be understood by one of ordinary skill in the art. For example, a graph such as the graph of FIG. 1B can be generated by an oscillatory temperature sweep method, at a 1 Hertz frequency, from temperatures below Tg of the material to temperatures above a melt temperature of the material. The cross-over point can be shifted with the frequency, as will be understood by one of ordinary skill in the art. Various equipment can be used to perform this method, including a Rheometer, such as an AR 2000, using a parallel plate or a cone and a plate.

As previously mentioned, the mass redirection process of the present system 10 may be utilized while the material is above the cross-over temperature. Throughout the present disclosure a temperature at or above the cross-over temperature can also be referred to as a forging temperature. The material can also be heated well above the cross-over temperature. However, if the temperature is too high, the material may be so flowable that it is not easy to handle or may not be easily formed into film, due to melt instability. Similarly, the temperature will typically be above the cross-over temperature and not directly at it. As a result, the pressure used to perform mass redirection is reduced, along with dwell time.

In an embodiment, prior to leaving the forging devices 40 and 50, the extrudate 30 is retained at the extrusion temperature, such as the manufacturer's recommended extrusion temperature, of the material, within +/−10° F. For example, for polypropylene extrusions the temperature may retained at 390° F.+/−10° F., and for polyethylene extrusions the temperature may be retained at 350° F.+/−10° F. Wider or narrower temperature variances are within the scope of the invention, where the extrudate is in its semi-solid state or soft-solid state, capable of being redirected with the present system and method.

Prior to the mass redirection process of the forging system 10, the material can be any temperature desired. In an embodiment, the extrusion die 20 may deliver the extrudate 30 at a temperature lower than the cross-over temperature, and the extrudate 30 may be heated to above the cross-over temperature prior to reaching the point of tangency 12 of the forging devices 40 and 50. In an embodiment, the extrusion die 20 may deliver the extrudate 30 at, or above, the cross-over temperature. In an embodiment, the extrusion die 20 may deliver the extrudate 30 at a temperature well above the cross-over temperature. In some embodiments, the extrudate 30 may be delivered from the extrusion die 20 at a higher temperature than needed for mass redirection, such as to reduce backpressure in the extrusion die 20 or to increase flow of extrudate 30 from the extrusion die 20. In cases where the extrudate 30 is delivered from the extrusion die 20 at a temperature well above the cross-temperature, the extrudate 30 may be cooled, if desired, before reaching the point of tangency 12 of the forging devices 40 and 50. Cooling the extrudate 30 may be done in any number of ways, including through the use of ambient air, chilled rolls, or other cooling means as will be understood by one of ordinary skill in the art.

Some materials, such as elastomeric materials, show order-disorder morphological behavior and may not have a clear melt point but instead can be described as having an order-disorder temperature, e.g. styrenic block copolymer material SEPTON 4033 available from Kurary Inc. For such materials, the mass redirection process of the present system 10 may be above the order-disorder temperature, instead of the cross-over temperature. Throughout the present disclosure a temperature at or above the order-disorder temperature can also be referred to as a forging temperature.

With the present system 10, the extrudate 30 may leave the forging devices 40 and 50 while the extrudate 30 is below the cross-over temperature. That is, after the extrudate 30 has been formed into the carrier film 72 having integrally formed core elements 70, as discussed herein, and as the carrier film 72 and the core elements 70 are leaving the forging devices 40 and 50, the carrier film 72 and the core elements 70 may be below the cross-over temperature of the extrudate 30. If the carrier film 72 and the core elements 70 are not below the cross-over temperature as they leave the forging devices 40 and 50, the carrier film 72 and the core elements 70 may be flowable. In an embodiment, the temperature at which the carrier film 72 and the core elements 70 leave the forging devices 40 and 50 may be such that the carrier film 72 and the core elements 70 are in semi-solid, soft-solid, or solid form. In various embodiments, the temperature is close to or less than the cross-over temperature where the core elements lose contact with voids and/or protrusions on the forging devices.

The temperature of the extrudate 30 between the time the extrudate 30 first contacts the forging devices 40 and 50 and the time the extrudate 30 leaves the forging devices 40 and 50 may vary. The temperature variation between these points may occur naturally over the dwell time in the mass redirection process or may be controlled by addition or removal of heat, such as by heating or cooling of either or both of the forging devices. The extrudate 30 may be held at a temperature at which the mass can be redirected for a sufficient dwell time for a desired amount of mass redirection to occur.

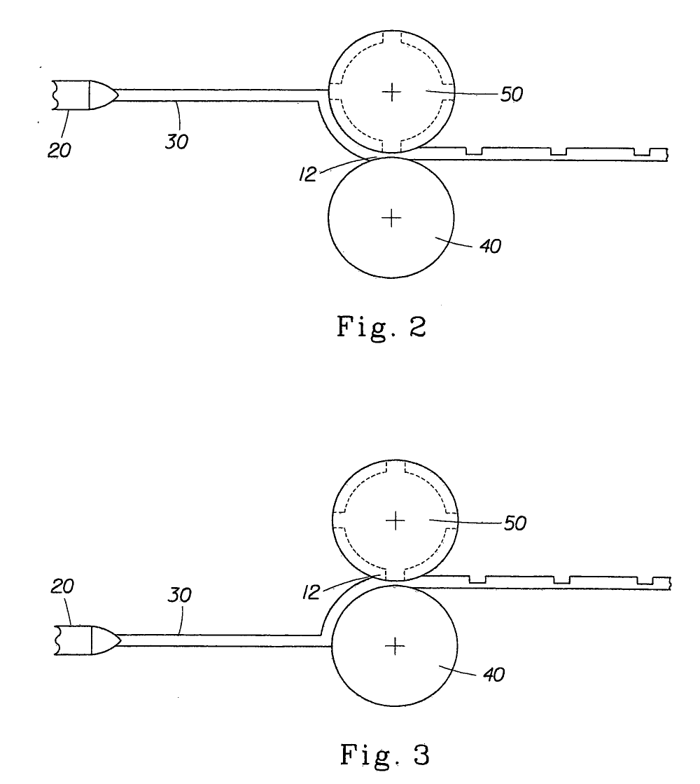

In an embodiment, the extrudate 30 may be extruded proximate the point of tangency 12 of the first and second forging devices 40 and 50. In other embodiments, the thermoplastic material may be extruded at any suitable location, as illustrated in FIGS. 2 through 4. In such alternative embodiments, while the extrusion die 20 continues to supply the extrudate 30 to the forging devices 40 and 50, the extrudate 30 may be carried on a predetermined path along the peripheral surface of either first forging device 40 or second forging device 50 and may pass through the point of tangency 12 of the first and second forging devices 40 and 50. The void regions 54 on second forging device 50 may be aligned to redirect, or reallocate, the extrudate 30 as the extrudate 30 passes through the point of tangency 12, thereby filling one or more of the void regions 54. The result of the redirection of extrudate 30 as it passes through forging devices 40 and 50 is a carrier film 72 having integrally formed core elements 70.

The shapes of the void regions 54 form the shapes of core elements 70. A suitable fixed width nip or pressure from the forging devices 40 and 50 presses the extrudate 30 completely into the void regions 54 as the extrudate 30 passes through the point of tangency 12 of the first and second forging devices 40 and 50. The clearance or pressure of the nip may be controlled so that the thickness of the core elements 70 and/or the thickness of the carrier film 72 can be adjusted. By selecting an appropriate fixed clearance or pressure of the nip, the forging devices 40 and 50 may operate to press a substantial portion of the extrudate 30 into the void regions 54 and reduce the amount of excess extrudate 30 that is delivered by the extrusion die 20 but ultimately not included in the core elements 70. Generally, the volume of extrudate 30 used in the forging system 10 of the present invention may be generally equal to the sum of the volume of filled void regions 54, the volume of material used for the carrier film 72, and the volume of excess extrudate which is neither a part of the resulting core elements 70 nor the carrier film 72. The volume of the excess extrudate may be reduced or eliminated in an embodiment. Generally, in other embodiments, the excess extrudate is squeezed out of the sides of the forging devices 40 and 50, allowed to solidify, and later trimmed off. In other embodiments, a nip may cause excess extrudate to flow through recessed escape holes located on the peripheral surface of one or both of the forging devices 40 and 50, or the excess material may be wiped or removed from the peripheral surfaces of one, or both, of the forging devices 40 and 50 by a scraper acting against or proximate to the peripheral surface 42 and/or 52 of the first and/or second forging devices 40 and 50. Alternatively, the peripheral surface 42 may include grooves or channels that capture excess material, and guide it toward a collection apparatus, such as at each lateral end of the forging devices 40 and 50. The excess material may be addressed or redirected in any suitable manner. In any embodiment, such excess extrudate may be recycled and re-provided by extrusion die 20.

In an embodiment, the thermoplastic material may travel through the point of tangency 12 of the first and second forging devices 40 and 50 and onto further processing. In another embodiment, the thermoplastic material may travel adjacent the peripheral surface 42 of the first forging device 40 after passing through the point of tangency 12 of the first and second forging devices 40 and 50 and may be removed from forging device 40. Prior to the material departing the first forging device 40, the material may be cooled below its cross-over temperature and brought from the semi-solid state to a substantially solid state, which may assist the material in holding its shape formed by the void regions 54, thus producing regularly shaped core elements 70 in a repeatable and consistent manner. The material may begin to solidify in the void region's 54 shape at or somewhat below the extrusion temperature, and as the material cools beneath that temperature, the material enters into a solid state. However, the temperature of the material is controlled so that the material does not enter into a solid state prior to completing the mass redirection to the desired extent. The temperature may be controlled in any suitable manner, including by controlling the temperature of the facility, the temperature of the forging device 40, the temperature of the forging device 50, etc. The temperature of the forging devices 40, 50 may be controlled by electrical elements, a cooling fluid such as glycol, with hot or cold water, etc. The desired temperature of the material prior to being peeled form the forging device 40 may be determined based upon the viscosity of the material and on the specific geometry of the void region 54. In various embodiments, the temperature is close to or less than the cross-over temperature where the material peels away.

In an embodiment, the first forging device 40 may be chilled to a temperature sufficiently below the cross-over temperature of the extrudate 30 so that, after the extrudate 30 is delivered to the first forging device 40, and as it rotates about the forging device 40, the extrudate 30 solidifies sufficiently rapidly to ensure that it enters into a solid state before the extrudate 30 departs the forging device 40. In an embodiment, the second forging device 50 may, in addition to or instead of the first forging device 40, be cooled to assist in bringing the extrudate into a solid state. In an embodiment, the forging devices 40 and/or 50 are chilled to a temperature significantly below the temperature during the mass redirection process, for example temperatures 25° F., 50° F., 75° F., or 100° F. or more below, which may assist in maintaining fidelity of a core element 70 to the shape of the void regions 54. By chilling devices 40 and/or 50, the temperature of the extrudate 30 can be decreased so that the material solidifies from its previous semi-solid state at a rate faster than would be accomplished than by cooling from devices with uncontrolled temperatures. In various embodiments, part or all of the forging devices can be cooled. Accordingly, the forging device 40, and thus the rotary forging system 10, may operate at a rate faster than would be practicable without chilled forging devices.

The integral core elements 70 and the carrier film 72 together form a web 75. The web 75 may travel through rollers 320 that adhesive bonds webs of nonwoven or other material 322 to one or both sides of the web 75. Adhesive is applied at glue stations 324 and may be applied to all or part of the webs of nonwoven or other material 322. Alternatively, the nonwoven or other material 322 may be bonded to the web 75 through other suitable means, including lamination, high-pressure bonding, etc. When webs of nonwoven or other material 322 are bonded to both sides of the web 70, 72, the web 70, 72 is sandwiched by the nonwoven or other material 322.

With reference to FIGS. 1 through 4, the extrusion die 20 may be located in any one of a plurality of positions for extruding thermoplastic material onto, or toward, the first and second forging devices 40 and 50. The locations of the extrusion die 20 shown in the Figures are for illustration only and are not limiting to the present invention. The extrusion die 20 may be located in any position that will result with the extrudate 30 passing through the point of tangency 12 of forging devices 40 and 50. With reference to FIG. 1A, the extrusion die 20 may be located in a position to extrude thermoplastic material directly between, and tangent to both, forging devices 40 and 50. With reference to FIG. 2, the extrusion die 20 may be located in a position to extrude thermoplastic material onto a forging device 50 having voids or protrusions in or on the peripheral surface. With reference to FIG. 3, the extrusion die 20 may be located in a position to extrude thermoplastic material onto a forging device 40 having a smooth peripheral surface.

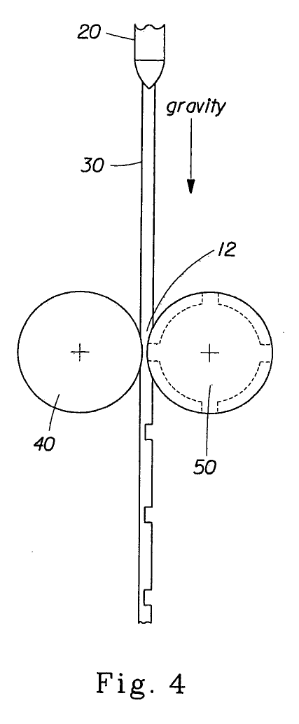

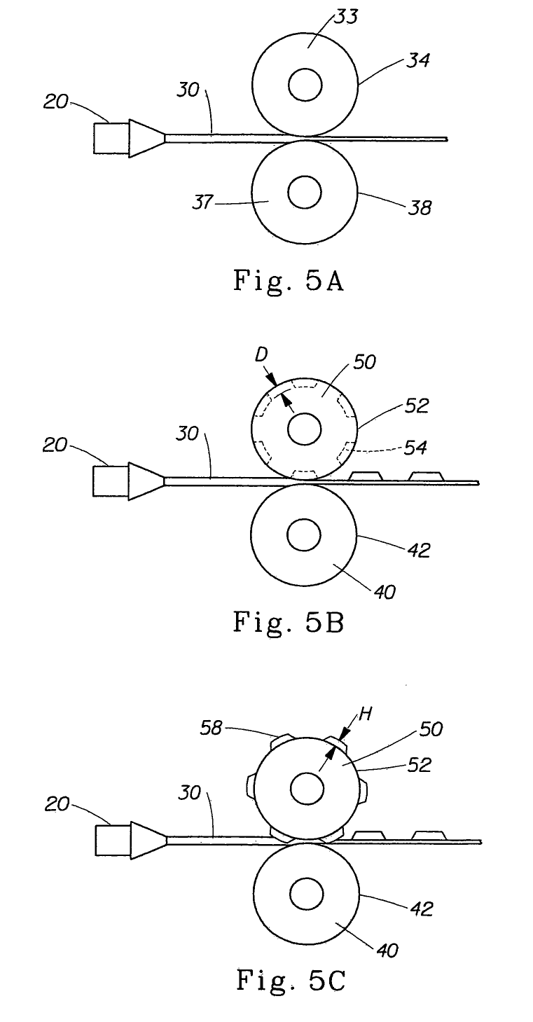

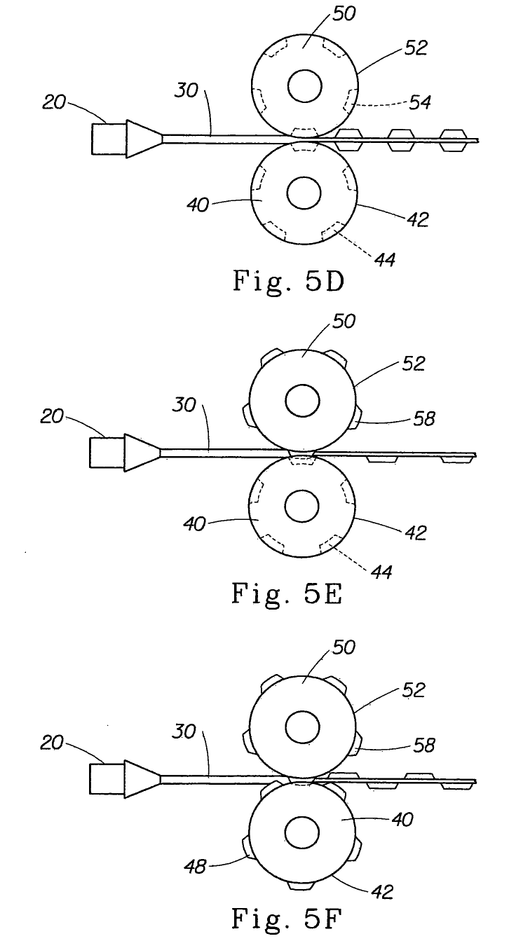

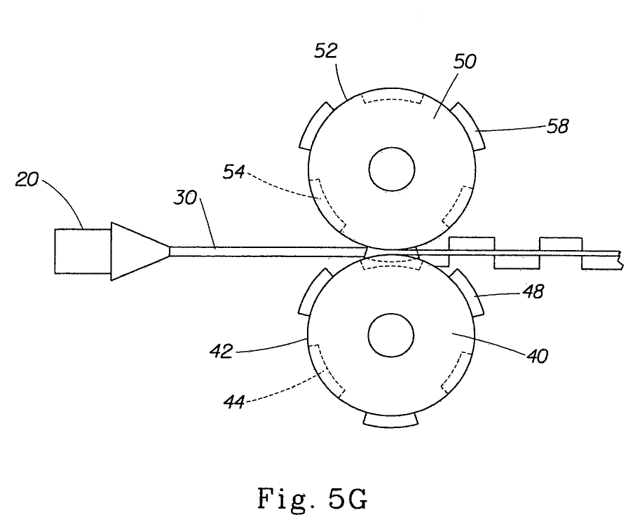

In any position, with reference to FIG. 4, the force of gravity may be used to guide the extrudate to the forging devices. Although the use of the force of gravity is illustrated with the extrusion die 20 delivering the extrudate 30 directly to the point of tangency 12 of the forging devices 40 and 50, it is recognized that the force of gravity can be used with any position of the extrusion die 20, as previously mentioned. Similarly, the extrusion die 20 may supply the extrudate 30 directly to the forging devices 40 and 50, or preprocessing may be performed before the extrudate 30 enters the point of tangency 12 of the forging devices 40 and 50. Preprocessing may include, but is not limited to, drawing down, or thinning, the extrudate 30 by elongating it, heating or cooling the extrudate 30 to the desired forging temperature, discussed herein, or subjecting the extrudate 30 to a device to maintain a desired temperature. For example, with reference to FIG. 5A, extrudate 30 may pass through a pair of preprocessing rollers 33 and 37 to thin the extrudate 30 or add/remove heat to the extrudate 30 prior to the extrudate 30 entering the forging devices. The preprocessing rollers 33 and 37 have surfaces 34 and 38 which may be smooth or may be designed to impart a texture to the extrudate 30.

In other embodiments, illustrated in FIGS. 5B through 5G, the peripheral surfaces 42 and 52 of each forging device 40 and 50 may include one or more void regions 44 and 54 with an exemplary depth D below the peripheral surface, one or more protrusions 48 and 58 with an exemplary height H above the peripheral surface, or any combination of void regions 44 and 54 and protrusions 48 and 58, as desired. Such void regions and protrusions can also be generally referred to as forging regions. For example, the peripheral surface 42 of first forging device 40 may be smooth while the peripheral surface 52 of second forging device 50 may comprise void regions 54, as shown in FIG. 5B, or vice versa. In another embodiment, the peripheral surface 42 of first forging device 40 may be smooth while the peripheral surface 52 of second forging device 50 may comprise protrusions 58, as shown in FIG. 5C, or vice versa.

In another embodiment, the peripheral surfaces 42 and 52 of both the first and second forging devices 40 and 50 may comprise void regions 44 and 54, as shown in FIG. 5D. In an embodiment as illustrated in FIG. 5D, the peripheral surfaces 42 and 52 of the first and second forging devices 40 and 50 may both define void regions 44 and 54. In a further embodiment, void regions 54 of forging device 50 form one side of the desired core element 70 shape, and void regions 44 of forging device 40 may be phased to form an opposing side of the desired core element 70 shape. The extrusion die 20 may deliver extrudate 30 to the first forging device 40 at the void regions 44, and void regions 44 rotate on the first forging device 40 in phase with the void regions 54 rotating on the second forging device 50, such that each void region 44 may be met by an opposing void region 54 at the point of tangency 12 between the forging devices 40 and 50. As a result, when an extrudate 30 rotates between the first forging device 40 and the second forging device 50, the extrudate 30 may be molded to match the shapes of the void regions 44 and 54 on opposing sides. In such an embodiment, the void regions 44 and 54 may be of the same shape, size, depth, etc., such that opposing sides of the resulting core element 70 are generally identical. Alternatively, the void regions 44 and 54 may differ in shape, size, depth, etc., such that opposing sides of the resulting core element 70 are different. When the first forging device 40 also defines void regions 44, additional thermoplastic material may be supplied at the time of delivery sufficient to completely fill phased void regions 44 and 54 on the forging devices 40 and 50. In yet other embodiments, first forging device 40 may have raised surfaces, projections, etc. that extend into the void regions 54 of the second forging device 50, second forging device 50 may have raised surfaces, projections, etc. that extend into the void regions 44 of the first forging device 40, or each forming device 40 and 50 may have raised surfaces, projections, etc. that extend into the void regions 44 and 54 of the other.

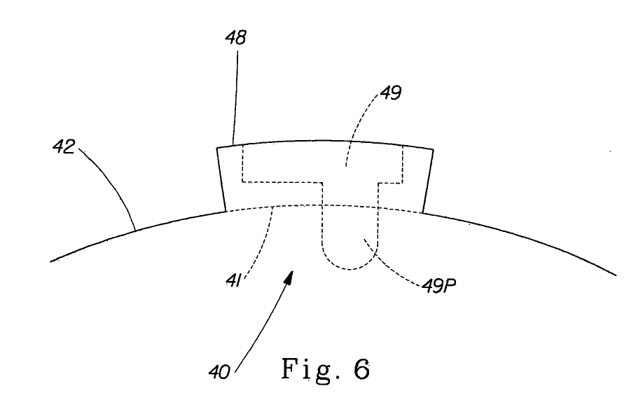

In another embodiment, the peripheral surface 42 of first forging device 40 may comprise void regions 44 while the peripheral surface 52 of second forging device 50 may comprise protrusions 58, as shown in FIG. 5E, or vice versa. In another embodiment, the peripheral surfaces 42 and 52 of both the first and second forging devices 40 and 50 may comprise protrusions 48 and 58, as shown in FIG. 5F. In another embodiment, the peripheral surface 42 or 52 of either forging device 40 or 50, or both, may comprise a combination of void regions 44 and 54 and protrusions 48 and 58. An embodiment wherein the peripheral surfaces 42 and 52 of both forging devices 40 and 50 comprise a combination of void regions 44 and 54 and protrusions 48 and 58 is illustrated in FIG. 5G. In another embodiment, the peripheral surface 42 of first forging device 40 may comprise a protrusion 48 having an integrated void region 49, as illustrated in FIG. 6. Similarly, the peripheral surface 52 of second forging device 50 may comprise a protrusion having an integrated void region. It will be recognized that any of the aforementioned embodiments of forging device configurations can be adapted for use with either, or both of, the forging devices 40 and 50 having protrusions with integrated void regions. Furthermore, an integrated void region of a protrusion may be made to such a depth that at least a portion 49P of the integrated void region would, in its deepest part, be a void region 44 or 54 in the peripheral surface 42 or 52 if the protrusion were not there, as illustrated by reference line 41, which extends from the peripheral surface 42 and forms part of a boundary for the portion 49P. In other embodiments, additional forging devices may be provided as needed to assist in creating the desired core element shape, and it is further recognized that either of the aforementioned combinations can be phased or staggered. For example, a first embodiment of forging devices can be followed by a second embodiment of forging devices.

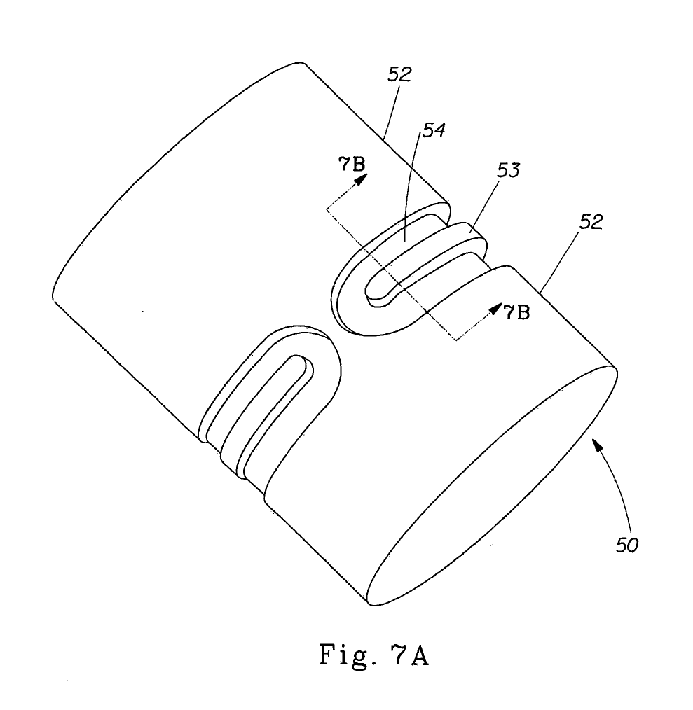

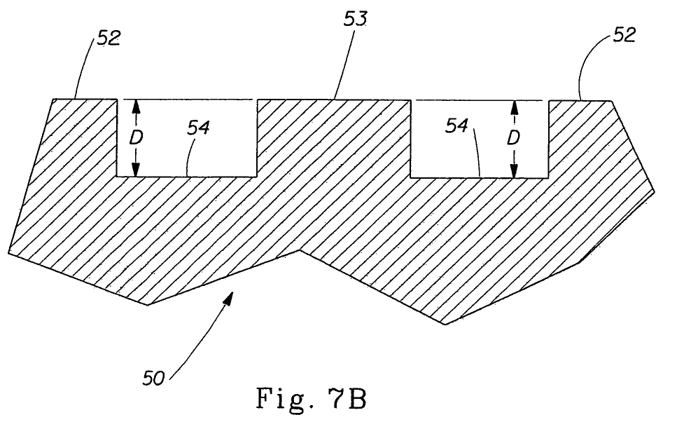

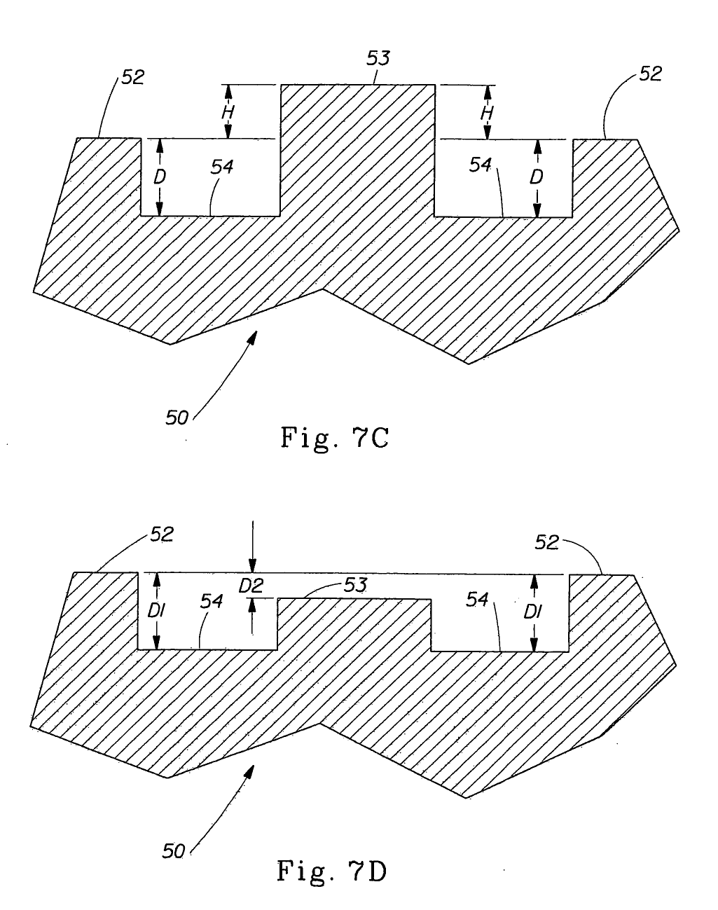

The void regions 54 that define the shape of a desired core element 70 may have a variety of shapes. Referring to FIG. 7A, in an embodiment where the core element 70 is part of a slot of a tab-and-slot fastening system for disposable absorbent articles, peripheral surface 52 of the forging device 50 may define slot fastener void regions 54, and region 53, arranged generally longitudinally in the generally circumferential direction of the forging device 50. Each slot fastener void region 54 may include multiple discrete regions therein with varying depths. The region 53 may be a void below the peripheral surface 52, as illustrated in the embodiment of FIG. 7C, a surface level with the peripheral surface, or a protrusion above the peripheral surface 52, as illustrated in the embodiment of FIG. 7A. Numerous configurations of regions within the voids having varying depths may be suitable for use with the present invention. The void regions 54 shown in FIG. 7A are for illustrative purposes only and are not limiting. Furthermore, it is recognized that multiple embodiments of the void regions 54 may be used not only in relation to slot fastener core elements, but in relation to void regions 54 for any desired core elements 70. FIG. 7A also includes section view arrows B-B, for illustrating the embodiments of FIGS. 7B, 7C, and 7D.

FIG. 7B is a partial sectional view of an embodiment of a portion of surfaces of a forging device in accordance with an embodiment of the present invention. The embodiment of FIG. 7B can be an embodiment of the sectional view B-B illustrated in FIG. 7A. The embodiment of FIG. 7B includes a portion of the forging device 50, the peripheral surfaces 52, the void regions 54, and a protrusion 53. In the embodiment of FIG. 7B, the void regions 54 are at a depth D below the peripheral surfaces 52 and the protrusion 53 is at about the same height as the peripheral surfaces 52.

FIG. 7C is a partial sectional view of an embodiment of a portion of surfaces of a forging device in accordance with an embodiment of the present invention. The embodiment of FIG. 7C can be an embodiment of the sectional view B-B illustrated in FIG. 7A. The embodiment of FIG. 7C includes a portion of the forging device 50, the peripheral surfaces 52, the void regions 54, and a protrusion 53. In the embodiment of FIG. 7C, the void regions 54 are at a depth D below the peripheral surfaces 52 and the protrusion 53 is at a height H above the peripheral surfaces 52.

FIG. 7D is a partial sectional view of an embodiment of a portion of surfaces of a forging device in accordance with an embodiment of the present invention. The embodiment of FIG. 7D can be an embodiment of the sectional view B-B illustrated in FIG. 7A. The embodiment of FIG. 7D includes a portion of the forging device 50, the peripheral surfaces 52, the void regions 54, and a second void region 53. In the embodiment of FIG. 7D, the void regions 54 are at a depth D1 below the peripheral surfaces 52 and the second void region 53 is at a depth D2 below the peripheral surfaces 52.

The core element 70 and/or the carrier film 72 formed may be of any desired smoothness. In certain applications, such as in use with absorbent articles, a smooth finish (without peaks, pits, or bumps) may be desirable, so as not to cause discomfort to the article's wearer, or to leave marks or impressions on the wearer's skin. In other applications, it may be desirable to impart a design, texture, pattern, or roughness to the core element 70 and/or the carrier film 72, or to a portion thereof, such as for functional or aesthetic reasons. Any of the aforementioned features, or variation of features, can be imparted to the core element 70 and/or the carrier film 72 by designing the void regions or protrusions of the forging devices to redirect the mass of the core element accordingly during the mass redirection process of the forging system 10, as described previously. In an embodiment, the aforementioned features, or variations of features, can be imparted to the core element 70 and/or the carrier film 72 in post-processing steps. Post-processing steps can include one or more of various processes, such as a second mass redirection process, a texturing process, and/or a smoothing process.

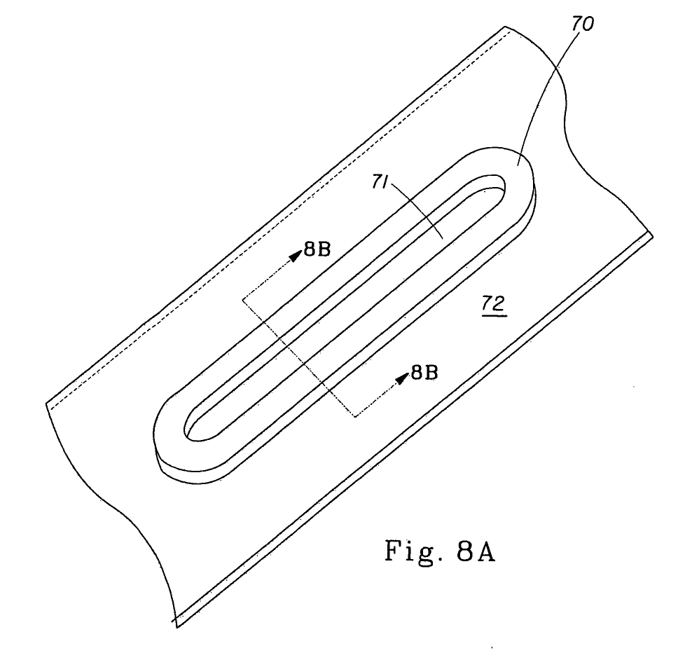

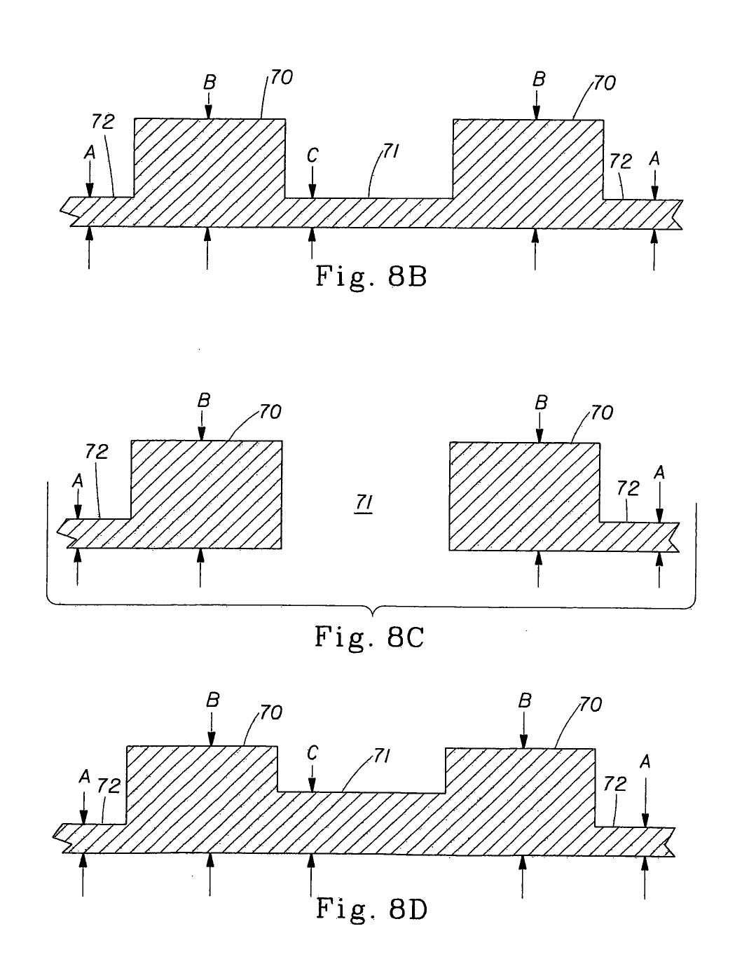

The forging device 50 of the embodiment of FIG. 7A can be used to form a core element 70 and an area 71 with a carrier film 72 as shown in FIG. 8A. FIG. 8A also includes section view arrows B-B, for illustrating the embodiments of FIGS. 8B, 8C, and 8D.

FIG. 8B is a partial cross-sectional view of an embodiment of the core element 70 with the carrier film 72 formed with a forging device in accordance with an embodiment of the present invention. The embodiment of FIG. 8B can be an embodiment of the sectional view B-B illustrated in FIG. 8A. The embodiment of FIG. 8B also illustrates the area 71 inside the core element 70. In various embodiments, the area 71 can be part of the core element 70, part of the carrier film 72, or an open area, depending on the configuration of the forging devices used. In the embodiment of FIG. 8B, the area 71 is part of the carrier film 72. The embodiment of FIG. 8B can be formed with the forging device of the embodiment of FIG. 7B, as will be understood by one of ordinary skill in the art. In the embodiment of FIG. 8B, the carrier film 72 has a thickness A, the core element 70 has a thickness B, which is greater than thickness A, and the area 71 has a thickness C, which is about the same as the thickness A. The thickness B in the embodiment of FIG. 8B corresponds with the thickness A and the depth D of FIG. 7B.

FIG. 8C is a partial cross-sectional view of an embodiment of the core element 70 with the carrier film 72 formed with a forging device in accordance with an embodiment of the present invention. The embodiment of FIG. 8C can be an embodiment of the sectional view B-B illustrated in FIG. 8A. The embodiment of FIG. 8C also illustrates the area 71 inside the core element 70. In the embodiment of FIG. 8C, the area 71 is an open area. The embodiment of FIG. 8C can be formed with the forging device of the embodiment of FIG. 7C, as will be understood by one of ordinary skill in the art. In the embodiment of FIG. 8C, the carrier film 72 has a thickness A and the core element 70 has a thickness B, which is greater than thickness A. The thickness B in the embodiment of FIG. 8C corresponds with the thickness A and the depth D of FIG. 7C.

FIG. 8D is a partial cross-sectional view of an embodiment of the core element 70 with the carrier film 72 formed with a forging device in accordance with an embodiment of the present invention. The embodiment of FIG. 8D can be an embodiment of the sectional view B-B illustrated in FIG. 8A. The embodiment of FIG. 8D also illustrates the area 71 inside the core element 70. In the embodiment of FIG. 8D, the area 71 is part of the core element 70. The embodiment of FIG. 8D can be formed with the forging device of the embodiment of FIG. 7D, as will be understood by one of ordinary skill in the art. In the embodiment of FIG. 8D, the carrier film 72 has a thickness A, the core element 70 has a thickness B, which is greater than thickness A, and the area 71 has a thickness C, which is greater than the thickness A and less than the thickness C. The thickness B in the embodiment of FIG. 8D corresponds with the thickness A and the depth D1 of FIG. 7D. The thickness C in the embodiment of FIG. 8D corresponds with the thickness A and the depth D2 of FIG. 7D.

In various embodiments, the ratio between the thickness of the carrier film 72 (thickness A shown in FIGS. 8B-8C) and the thickness of the thickest portion of a resulting integrally formed core element 70 (thickness B in FIGS. 8B-8C) can be from about 1:3 to about 1:20. In other embodiments, any other suitable ratio can be used. The ratio could be altered by, for example, but not limited to, increasing the pressure between the forging devices 40 and 50, varying the shape of the void regions 44 and 54 or protrusions 48 and 58 on the peripheral surfaces 42 and 52 of the forging devices 40 and 50, or altering the viscosity of the extrudate 30 by, for example, increasing the temperature of, or adding viscosity modifiers to, the extrudate 30. Additionally, other factors may be changed to alter the ratio, such as the dwell time, process conditions, such as temperature, pressure, and the like, or material type. Dwell time can be affected by diameter of the peripheral surface of the forging device, the number of degrees rotation pressure and/or temperature are maintained near the point of tangency 12, or by using a non-roll press, as illustrated in FIG. 15. It could be desirable in some embodiments to increase the ratio to about 1:10, about 1:30, about 1:100, or beyond. Increasing the thickness differential between the thickness of the carrier film 72 and the thickness of the thickest portion of a resulting core element 70 may result in increased excess extrudate. Such excess extrudate may be removed and recycled from extrusion die 20, as previously described. In an embodiment, the molded web 86 consisting of carrier film 72 having integrally formed core elements 70 is transferred downstream for further processing that includes adhering the molded web 86 to a web of nonwoven material and die cutting the resultant web into usable core elements. Exemplary macrofasteners which can be made by the present invention are described in U.S. Pat. No. 6,432,098. A suitable process for further manipulating such macrofasteners is described in more detail in U.S. Pat. No. 6,669,618. U.S. Pat. Nos. 6,432,098 and 6,669,618 are incorporated herein by reference.

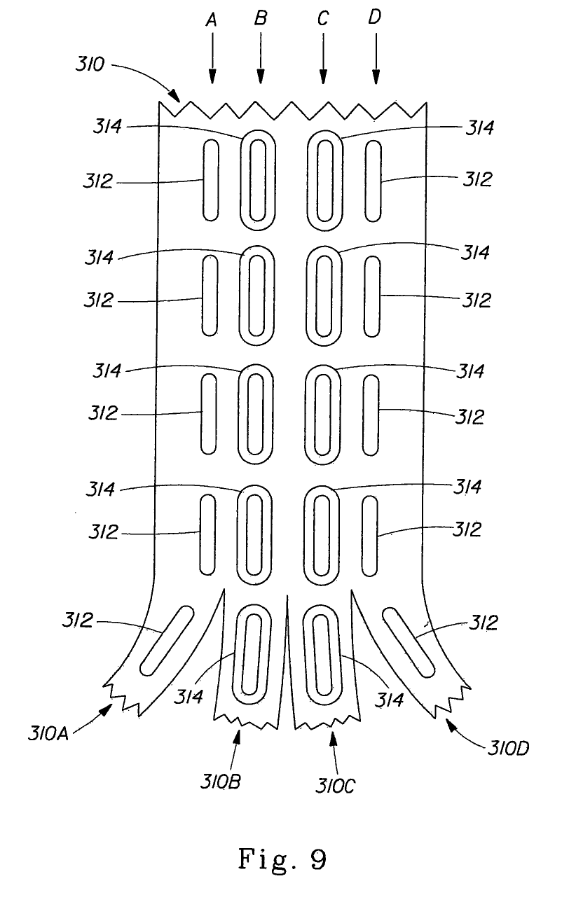

FIG. 9 depicts an example of a molded web 310 of carrier film 72 having integrally formed core elements 70 made pursuant to systems and methods of the present disclosure. Referring to the example of FIG. 9, in an embodiment, a molded web 310 includes four columns (A, B, C, and D) of core elements 70 that may be used to form the fasteners of a tab-and-slot fastening system for disposable absorbent articles. The core elements 312 in columns A and D may include tabs of the tab-and-slot fastening system, and the core elements 314 in columns B and C may include slots of the tab-and-slot fastening system. In this embodiment, the corresponding forging device may include void regions, corresponding to two tabs and two slots, with each individual tab and slot void region arranged longitudinally in the circumferential direction of the forging device. A shearing system can shear the molded web 310 into a number of discrete webs, such as four discrete webs, i.e., two tab webs 310A, 310D, along with two slot webs 310B, 310C. Each discrete web may be processed separately or in parallel. The processing for one of the fastener webs, slot web 310B, is now described, but those skilled in the art will appreciate substantially the same processing may also be applied to webs 310A, 310C, and 310D. Each discrete web 310A, 310B, 310C, and 310D may be processed separately. Alternatively, each the molded web 310 may be processed as one unit before separating the discrete webs 310A, 310B, 310C, and 310D or the discrete webs may be processing in any desired grouping.

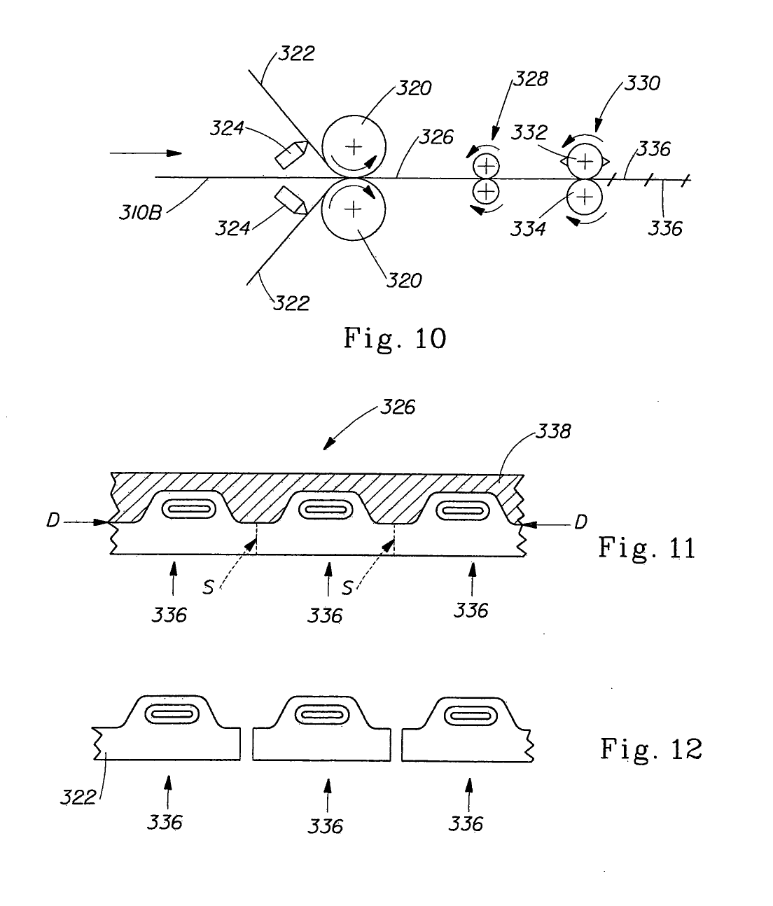

Referring to FIG. 10, slot web 310B travels in a predetermined path through rollers 320 that adhesive bonds webs of nonwoven or other material 322 to one or both sides of the slot web 310B. Adhesive is applied at glue stations 324 and may be applied to all or part of the webs of nonwoven or other material 322. Alternatively, the nonwoven or other material 322 may be bonded to the slot web 310B through other suitable means, including lamination, high-pressure bonding, etc. When webs of nonwoven or other material 322 are bonded to both sides, the slot web 310B is sandwiched by the nonwoven or other material 322. After the nonwoven or other material 322 is bonded to the slot web 310B by pressing devices 320, the resultant slot fastener web 326, in an embodiment, passes through a rotary die cutting station 328 that die cuts the slot fastener web 326 along the shaped line D (FIG. 11) into a form that more closely resembles its final shape and resulting in scrap material 338. The scrap material 338 from the die cutting process may be removed and disposed of. The resultant substrate then travels through a discretizing station 330, which may include an anvil device 334 and a knife device 332. As the devices rotate, the knife device 332 may cut the substrate against the anvil device 334 at shearing points S (FIG. 11) into individual completed slot members 336, as seen in FIG. 12, which may comprise the slot fasteners of a tab-and-slot fastening system. The individual completed slot members 336 are thereby formed into their final desired shape, which may subsequently be applied to a portion of an absorbent article to form a completed disposable absorbent article. Alternatively, the slot members 336 may be separated at any desired part of the process, either before or after being attached to an article.

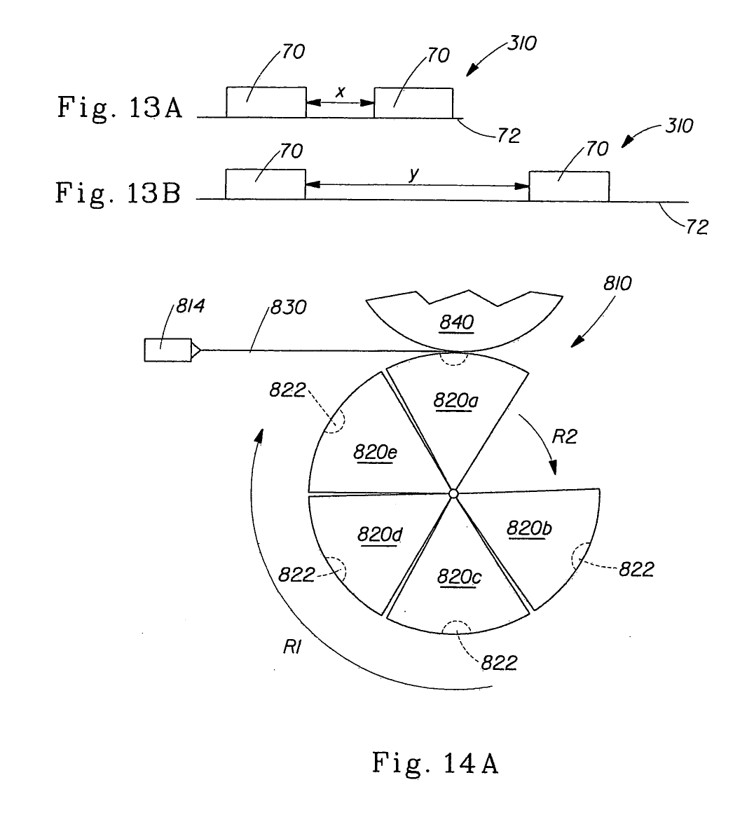

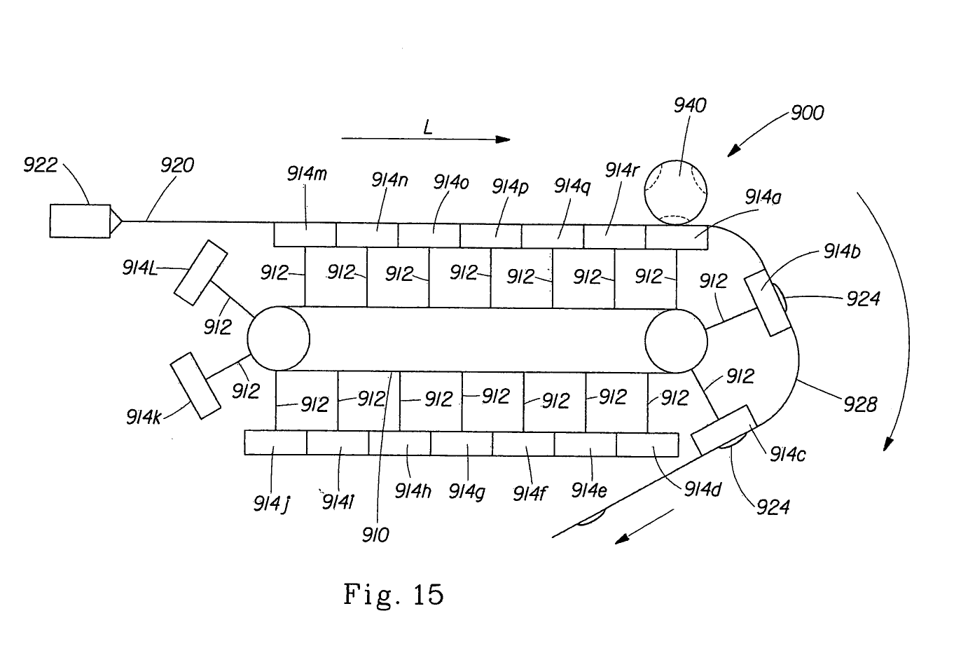

As previously described, after extrudate 30 has been formed into the desired shape and solidified into a molded web 310, the molded web 310 may then be joined with one or more webs of nonwoven or other material, or alternatively, may be used without being joined to another web of material. In an embodiment, the molded web 310 may be stretched prior to being joined with the nonwoven material or other substrate. Additionally, it may be desirable to space core elements 70 closely during extrusion and solidifying, which may reduce the amount of materials, e.g., extrudate 30, needed during manufacturing. With reference to FIG. 13A, an embodiment of molded web 310 comprises a carrier film 72 and solidified integrally formed core elements 70 formed therein, with the core elements 70 spaced distance X from one another. In an embodiment, the molded web 310 may be stretched in certain areas of the carrier film 72 so as not to affect the core elements 70. After the carrier film 72 is stretched, the core elements 70 are spaced distance Y from one another, where distance Y is greater than distance X, thus reducing a thickness of the carrier film 72 in the distance Y. Such a reduction can reduce material usage and decrease a stiffness of the carrier film 72. Where the carrier film 72 with closely spaced integrally formed core elements 70 (shown in FIG. 13A) is to be joined with a nonwoven web or other substrate at a pitch different than the spacing of the closely spaced core elements 70, a stretching process may facilitate matching the core elements 70 to the pitch of the web. This matching can be used, to avoid cutting the molded web 310 and re-positioning the core elements 70. For example, a carrier film 72 comprising a plurality of closely spaced fastener core elements 70 may be joined with a web of disposable absorbent article material(s), such as diaper cores, and the carrier film 72 may be stretched until the fastener core elements 70 are spaced to match the pitch of the diaper cores of the web. Stretching or stressing one or more of the webs also may impart desired properties to the web material.

Another reason for stretching the carrier film 72 is to reduce the thickness of these portions of the molded web 310. If the molded web 310 is too cool in temperature in these portions, increased force may be needed to stretch the carrier film 72 or the carrier film 72 might be sufficiently elastic that the application of force alone does not permanently deform the carrier film 72. As such, in an embodiment, the portion of the carrier film 72 that is between core elements 70 may be held at a different temperature than the core elements 70. In an embodiment, the temperature difference can be achieved by local cooling at each void or protrusion of a peripheral surface of a forging device and/or local heating between the void or protrusions on the peripheral surface of a forging device.

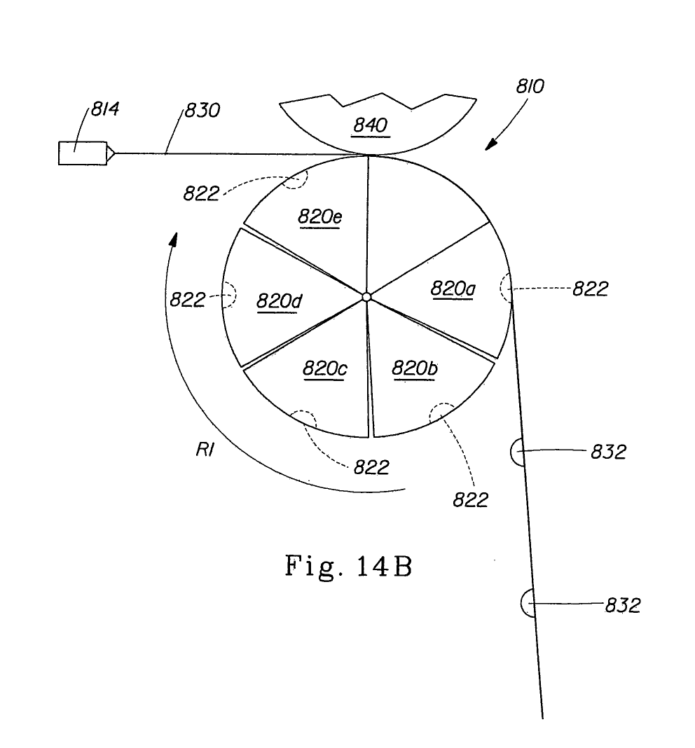

Referring to FIG. 14A, an embodiment a forging device 810 includes multiple pivotable segments, each pivotable segment defining a void region 822 in its surface and being independently rotatable from one another. The embodiment of FIG. 14A also includes a second forging device 840, shown in part, wherein the forging device 810 and the second forging device 820 can relate to each other as described in connection with the forging devices 40 and 50 of the embodiment of FIG. 1A. An extrusion die 814 delivers an extrudate 830 to the device 810 and tangentially engages a pivotable segment and void region 822 at the position held by segment 820a in FIG. 14A. Adjacent segments of the forging device 810 generally rotate at the same speed in the direction indicated by R1 in unison with the speed of the incoming extrudate 830. At a predetermined position in the rotation, occupied by segment 820a in FIG. 14A, after the segment receives, or contacts, the extrudate 830, the segment accelerates and rotates faster than the other segments, as indicated by R2, until the accelerated segment is adjacent the next segment, occupied by segment 820b in FIG. 14A, where the accelerated segment returns to the common rotation speed R1.

Referring to FIG. 14B, segment 820a is shown after accelerating until it is adjacent to the next segment 820b, thereby stretching extrudate 830 and spacing the forged core elements 832 by a predetermined amount. The molded web 812 travels away from the forging device 810 to the next stage of processing. The forging device 810 may be arranged to release core elements 832 from the pivotable segments either prior to, during, or after the segments are decelerated to match the speed of the other segments, depending on the overall configuration of the other system components. Each segment of a forging device with pivotable segments, such as the forging device 810 can utilize smooth surfaces, voids, protrusions, and combinations thereof, and can be used with a second forging device that can also utilize smooth surfaces, voids, protrusions, and combinations thereof, as described herein.

In another embodiment of the present invention, a conveyor system 900, as depicted in FIG. 15, can include a rotatable conveyor belt 910 and a plurality of conveyor support rods 912. Each support rod may hold a support plate (914a-914r) generally parallel to the conveyor belt 910. Each support plate may have a flat or non-flat surface, including having voids or protrusions, as previously described. In the example shown in FIG. 15, the support plates 914a-914r are generally arranged adjacent to one another. Other suitable arrangements may also be used. The belt 910 and plates 914a-914r travel in a substantially linear direction, as indicated by arrow L, until the plate reaches a radius of the conveyor belt 910, at which point the rods 912 and plates 914a-914r swing around the radius, thereby accelerating the swinging plates 914a-914r.

In operation, an extrusion die 922 delivers an extrudate 920 of suitable thermoplastic material into the conveyor system 900 and is carried along the linearly arranged support plates 914m-914r. The support plates 914a-914r rotate around a radius of the conveyor system in a direction indicated by arrow R, as shown with support plate 914b. The linear velocity of rotating support plate 914b is faster than the linearly traveling support plates, thereby stretching the extrudate 920. During the radial travel, the integrally formed core elements 924 become more spaced from one another than when formed in the forging device 940. The forging device 940 may comprise any of the embodiments of forging devices previously mentioned. In an embodiment, the extrudate 920 may be peeled off of the support plates 914a-914r before returning to their linear travel, as seen in FIG. 15. In other embodiments, the extrudate 920 may be peeled off of the support plates 914a-914r after returning to their linear travel. The molded web 928 may travel away from the conveyor system 900 to the next stage of processing as described above.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.

All documents cited in the Detailed Description of the invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and the scope of the invention. It is therefore intended to cover in the appended claims all such changes and modifications that are within the scope of this invention.

What is claimed is:

1. A method of forming thermoplastic material using rotary forging, the method comprising:
delivering a volume of a thermoplastic material;
transporting said thermoplastic material between a first rotating forging device and a second rotating forging device, the first forging device defining a first forging region in a surface thereof that receives said thermoplastic material, wherein said thermoplastic material is at or above a forging temperature and flows into said first forging region, thereby shaping an element from said volume;
substantially solidifying said thermoplastic material into the element; and
transferring the element from the first rotating forging device.

2. The method of claim 1, wherein the thermoplastic material is below the forging temperature at a point at which the thermoplastic material leaves the forging devices.

3. The method of claim 1, wherein a temperature of the thermoplastic material is changed between a first point at which the thermoplastic material is delivered and a second point at which the thermoplastic material leaves the forging devices.

4. The method of claim 1, wherein the second rotating forging device defines a second forging region in a surface thereon.

5. The method of claim 4, wherein said second forging region is phased with said first forging region, such that both said first and second forging regions receive said volume of the thermoplastic material and shape opposing sides of the element from said volume.

6. The method of claim 1, wherein the step of substantially solidifying said thermoplastic material includes providing at least one of the first forging device and the second forging device below the forging temperature of the thermoplastic material.

7. The method of claim 6, wherein at least one of the first forging device and the second forging device is provided at least about 25° F. or more below the forging temperature of the thermoplastic material.

8. The method of claim 1, wherein the step of transporting said volume of the thermoplastic material includes providing a nip pressure between the first forging device and the second forging device sufficient to cause said volume of the thermoplastic material to substantially fill said first forging region as the thermoplastic material passes between the first rotating forging device and the second rotating forging device.

9. The method of claim 1, wherein the volume of the thermoplastic material provides a film, the element being shaped therein.

10. The method of claim 9, wherein, after the element is shaped in the film, said film is stretched from a first length to a second length, said second length being greater than said first length.

11. The method of claim 1, further comprising the step of bonding the element to a web of material.

12. The method of claim 1, wherein the thermoplastic material is selected from the group including polyolefins, polyethylene terephthalates, polyamides, elastic polyolefins, other thermoplastic polyolefins, and combinations thereof.

13. A rotary forging system for forming core elements of a desired shape from extrudates, comprising:
a first rotating forging device defining a first forging region in a surface thereof; and
a second rotating forging device arranged proximate said first forging device;
wherein the rotary forging devices are configured to transport thermoplastic material between the first rotating forging device and the second rotating forging device, thereby aligning a volume of the thermoplastic material into the first forging region and shaping an element from said volume.

14. The rotary forging system of claim 13, wherein the second forging device has a temperature below the forging temperature of the thermoplastic material sufficient to substantially solidify said volume of the thermoplastic material into the element.

15. The rotary forging system of claim 13, wherein the second rotating forging device defines a second forging region in a surface thereon.

16. The rotary forging system of claim 15, wherein said second forging region is phased with said first forging region such that both said first and second forging regions receive said thermoplastic material and shape opposing sides of the element from said thermoplastic material.

17. The rotary forging system of claim 13, the second forging device has a temperature at least at least about 25° F. below the forging temperature of the thermoplastic material.

18. The rotary forging system of claim 13, wherein the first rotating forging device and the second rotating forging device are configured to provide a nip pressure therebetween sufficient to press said volume of the thermoplastic material into said first forging region as the thermoplastic material passes between the first rotating forging device and the second rotating forging device.

19. The rotary forging system of claim 13, wherein the first rotating forging device and the second rotating forging device are positioned with a fixed nip width therebetween to press said volume of the thermoplastic material into said first forging region as the thermoplastic material passes between the first rotating forging device and the second rotating forging device.

20. The rotary forging system of claim 13, configured to bond the element to a disposable absorbent article.
